(19) United States
(12) Patent Application Publication
(10) Pub. No.: US 2021/0064393 A1
(43) Pub. Date: Mar. 4, 2021

(54) SYSTEMS AND METHODS FOR CONTEXT AND OCCUPANT RESPONSIVE USER INTERFACES IN VEHICLES

(71) Applicant: TOYOTA MOTOR NORTH AMERICA, INC., PLANO, TX (US)

(72) Inventors: ALYSSA PIPE, Plano, TX (US); NUTONYA L. PARKER, Dallas, TX (US); SHALINI KESHAVAMURTHY, Sunnyvale, CA (US); GAGANDEEP SINGH SAINI, Plano, TX (US); PRASHANT V. SANAP, Frisco, TX (US); NATHAN KOKES, Frisco, TX (US); MICHAEL C, EDWARDS, McKinney, TX (US); DANY BENJAMIN, Rowlett, TX (US)

(21) Appl. No.: 16/554,400

(22) Filed: Aug. 28, 2019

(51) Int. Cl. G06F 9/451; G06F 3/14; G06N 20/00

(52) U.S. Cl. CPC G06F 9/451; B60K 37/06; G06N 20/00; G06F 3/14

(57) ABSTRACT

The progression of technology in vehicles has enhanced the driver's as well as passenger's experience. A sizable portion of the progression is the evolution of the human-machine interface. Nowadays, incorporating several user interfaces within a single vehicle is the standard. Accordingly, improving an occupant's interaction with these user interfaces is fundamental to cultivating the optimum occupant experience. The presently disclosed technology fulfills this objective by creating customized user interfaces for a vehicle. Each customized user interface is formed through the fusion of data from sensors within and around the vehicle tracking the occupant as well as vehicle interactions with each other and the environment. The wealth of information obtained simultaneous advances each individual occupant's experience by modifying associated user interfaces in accordance with the occupant's identified wants and needs.

### TECHNICAL FIELD

The present disclosure relates generally to a customizable vehicle display environment, and in particular, some implementations may relate to personalized displays based on occupant identity and respective seating position.

### DESCRIPTION OF RELATED ART

Vehicles often include systems such as infotainment and navigation systems. These systems are generally provided with a display on/around which various functions are arranged, effectuating a user interface that can be used by a driver and/or passengers of a vehicle. For example, the user interface of a vehicle's infotainment system may be implemented by mounting the aforementioned display in a dashboard of a vehicle cabin for the driver to interact with. As another example, another user interface for the infotainment system may be incorporated into some vehicle infrastructure, e.g., at the rear of a center console, to provide access to the infotainment system for passengers in the rear compartment.

Conventional user interfaces regardless of position within the vehicle embody generic configurations to accommodate the greatest majority of the population. Consequently, occupants make manual adjustments to customize the display environment of user interfaces to align with their position, orientation, and preferences. Unfortunately, due to the numerous functions typically available, occupants may require a relatively substantial amount of time, e.g. to find the desired control element in a complex interface or to browse through menus and submenus to access a desired function. While existing systems have attempted to accommodate the individual preferences of occupants through automated driver identification, driving style, and driving conditions; there fails to be any system that selectively customizes user interfaces based on both the identity of the occupant and their respective seating position.

### BRIEF SUMMARY OF THE DISCLOSURE

According to various embodiments of the disclosed technology systems and methods for vehicles may automatically configure user interface parameters that relate to an occupant's behavior in accordance with the location the occupant is in the vehicle. Sensor data can be collected and evaluated to customize the display of various user interfaces. For example, data concerning interactions with user interfaces as well as occupant characteristics including location can be collected, learned and used to build a profile. These profiles can be used automatically configure user interfaces so that the display configuration is more appropriate to the specific user. The various embodiments include:

A method of customizing a vehicle display environment for a vehicle, comprising: determining an occupant identifier for each of a plurality of occupants in the vehicle; determining a seating position occupied by each of the plurality of occupants in the vehicle and a UI corresponding to each occupied seating position; and configuring each UI corresponding the occupied seating positions to customize each UI for the occupant at the corresponding seating position based on the determined occupant identifiers.

A method of operating a system for a vehicle, comprising: detecting an occupant in the vehicle; identifying by an occupant identification subsystem whether the occupant is a previous user or a new user; identifying by an position identification subsystem whether the occupant is a passenger or a driver; assigning an occupant identifier based on the identifications from the occupant identification subsystem and the position identification subsystem; and generating an output for display on at least one vehicle interface corresponding to the occupant identifier.

A non-transitory machine-readable medium having instructions stored therein, which when executed by a processor, cause the processor to perform operations, the operations comprising: determining an occupant identifier for each of a plurality of occupants in a vehicle; determining a seating position occupied by each of the plurality of occupants in the vehicle and a UI corresponding to each occupied seating position; and configuring each UI corresponding to the occupied seating positions to customize each UI for the occupant at the corresponding seating position based on the determined occupant identifiers.

A customizable vehicle display system, comprising: a position determination system to determine a seating position and a UI corresponding to each occupied seating position for each of a plurality of occupants in a vehicle; an occupant display customizing circuit to determine an occupant identifier corresponding to the determined seating position; and wherein the occupant display customizing circuit is further configured to apply the determined occupant identifier to each occupied seating position to alter a display of the UI to conform to occupant characteristics.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for a customizable vehicle display environment in accordance with one embodiment of the systems and methods described herein.

FIG. 3 illustrates an example process for customizing a vehicle display environment in accordance with one embodiment of the systems and methods described herein.

FIG. 4 illustrates an example system for automated vehicle display dynamics in accordance with one embodiment of the systems and methods described herein.

FIG. 5 illustrates an example process for applying identifiers/profiles to a vehicle in accordance with one embodiment of the systems and methods described herein.

FIG. 6 illustrates an example computing component that may be used to implement various features of embodiments described in the present disclosure.

The figures are not exhaustive and do not limit the present disclosure to the precise form disclosed.

### DETAILED DESCRIPTION

Embodiments of the systems and methods disclosed herein can provide systems and methods for vehicles to automatically configure operating parameters that relate to the display environment in accordance with the identity and location of the occupant in the vehicle. Data sourced from a number of contributors including, for example, in-vehicle sensors, user interface detectors, client devices, infrastructure elements, other applications and databases, can be collected and evaluated to personalize user interfaces in a vehicle. The type, age, weight, height, movement, position, preferences and other identifying characteristics of passengers can be collected from these sources, learned and used to build profiles within the various user interfaces in the car. These profiles can be used to automatically configure the user interfaces in vehicles so that the content, functions, and orientation are more appropriate in view of occupant's identity and location., or that may be more in line with driver and passenger expectations for customized displays.

Data analytics and Al/ML technologies can be used to collect and analyze the data and build models for vehicle profiles or identifiers for various occupants. The profiles can be stored in the vehicles or in the cloud, and retrieved and applied when an occupant enters a vehicle. They can also be pushed to user devices as occupants travel from area to area. In further embodiments, identifiers/profiles for a vehicle can be set based on the occupant's place of residence or other “home base” of operations. The identifiers/profiles may be applied to conventional vehicles, semi-autonomous vehicles and fully autonomous vehicles.

User interface features can be modified to conform to the known or learned behaviors of the user. For example, the system can automatically adjust the display to emphasize frequently used features by presenting most frequently accessed applications with larger icons or a brighter setting. The system also takes into account the occupant's location, and the settings can be adjusted to respond differently to passenger profiles or driver profiles

Similarly, user interface features such as home screen appearance can be adapted to be more in line with the vehicle parameters or conditions. For example, when a vehicle is towing a trailer, functions related to towing may be displayed in a prominent position on a home screen, or a button to aid access to particular tow functions for the user. Moreover, the ability to utilize tow functions will only be allocated to user interfaces which have permitted occupant characteristics. For example, driving regulations may specify that only adults are permitted to tow a load, in which case, only user interfaces corresponding with adult profiles may be displayed to include tow functions at those seating positions where adults are present. Other examples include prominently displaying specific driving modes when sensors in the vehicle identify various weather conditions such as snow, ice, rain, or uneven terrain.

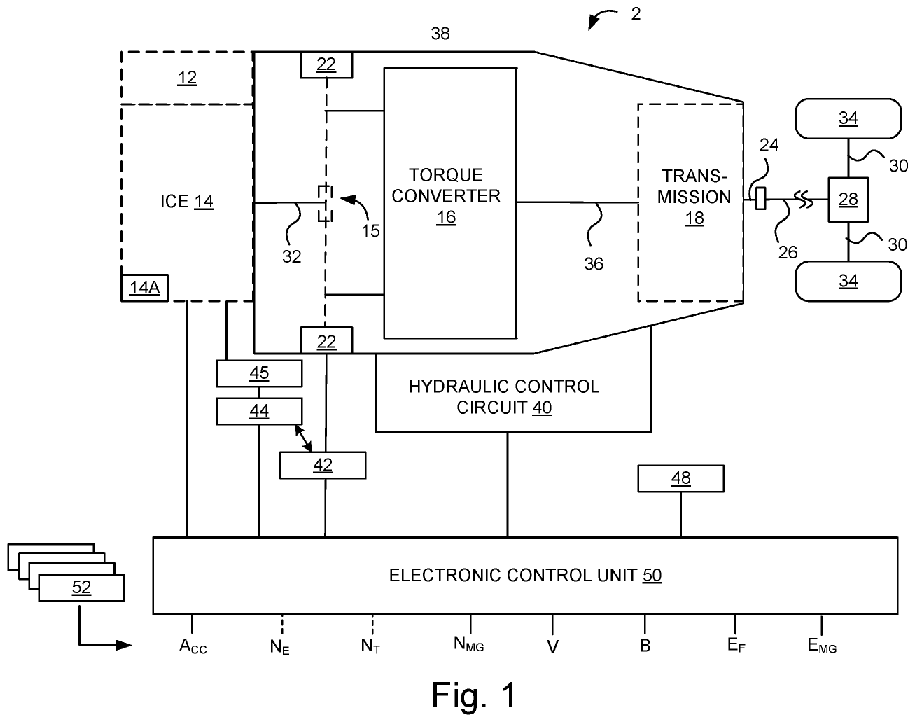

FIG. 1 is an example vehicle with which the technology disclosed herein may be implemented. The systems and methods disclosed herein may be implemented with any of a number of different vehicles and vehicle types. For example, the systems and methods disclosed herein may be used with automobiles, trucks, motorcycles, recreational vehicles and other similar on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for Al controlled vehicle display dynamics can be implemented in other types of vehicle including gasoline- or diesel-powered vehicles, fuel-cell vehicles, electric vehicles, or other vehicles.

FIG. 1 illustrates a drive system of a vehicle 2 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 2 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 2. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 2 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

In various embodiments, a customizable vehicle display system can be provided to create a personalized user interface for each occupant in accordance with an occupant profile and respective seating position. The system can be self-contained within the vehicle (e.g., as part of the vehicle infotainment system) and make tailored modifications based on data stored at the vehicle or data received in real time from other remote sources (e.g., cloud-based).

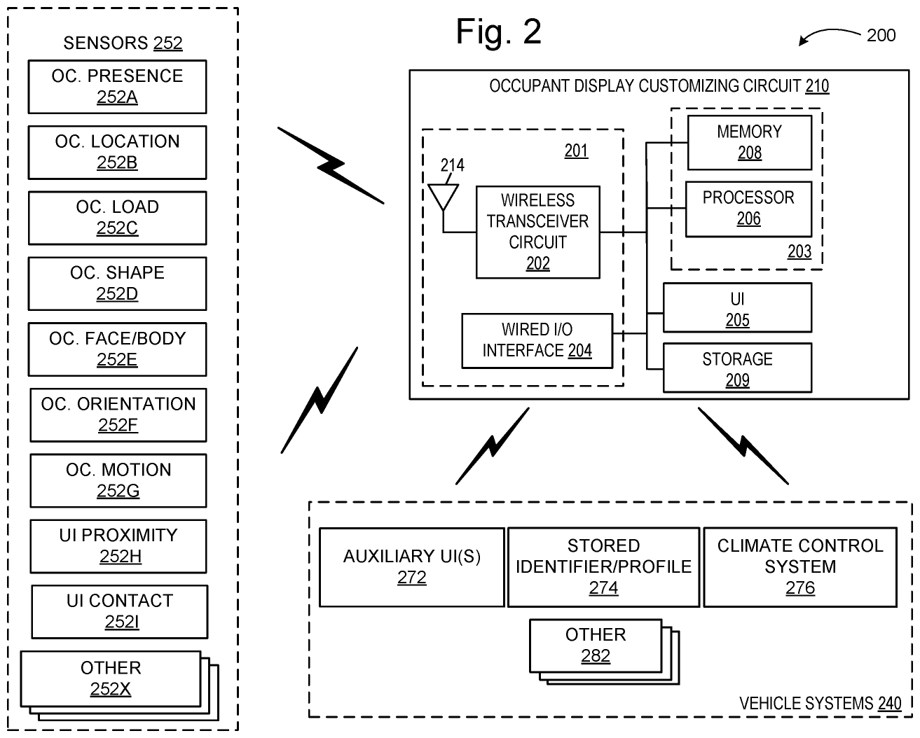

FIG. 2 illustrates an example architecture for implementing customized user interfaces in accordance with one embodiment of the systems and methods described herein. Referring now to FIG. 2, in this example, customized vehicle dynamic display system 200 may include an occupant display customizing circuit 210, plurality of sensors 252, and a plurality of vehicle systems 240. Sensors 252 and vehicle systems 240 can communicate with occupant display customizing circuit 210 via a wired or wireless communication interface. Although sensors 252 and vehicle systems 240 are depicted as communicating with occupant display customizing circuit 210, they can also communicate with each other as well as with other vehicle systems. Occupant display customizing circuit 210 can be implemented as an electronic control unit (ECU) or as part of an ECU such as, for example electronic control unit 50. In other embodiments, occupant display customizing circuit 210 can be implemented independently of the ECU.

Occupant display customizing circuit 210 in this example, includes a communication circuit 201, a decision circuit 203 (including a processor 206 and memory 208 in this example), user interface 205, and data storage 209. Components of occupant display customizing circuit 210 are illustrated as communicating with each other via a data bus, although other communication interfaces can be included. Occupant display customizing circuit 210 in this example also includes a user interface 205 that can be operated by the user to manually select various applications and/or display configurations.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208 can be made up of one or more modules of one or more different types of memory, and may be configured to store data and other information as well as operational instructions that may be used by the processor 206 to occupant display customizing circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up an occupant display customizing circuit 210.

Communication circuit 201 either or both a wireless transceiver circuit 202 with an associated antenna 214 and a wired I/O interface 204 with an associated hardwired data port (not illustrated). As this example illustrates, communications with occupant display customizing circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by occupant display customizing circuit 210 to/from other entities such as sensors 252 and vehicle systems 240.

Wired I/O interface 204 can include a transmitter and a receiver (not shown) for hardwired communications with other devices. For example, wired I/O interface 204 can provide a hardwired interface to other components, including sensors 252 and vehicle systems 240. Wired I/O interface 204 can communicate with other devices using Ethernet or any of a number of other wired communication protocols whether standardized, proprietary, open, point-to-point, networked or otherwise.

User interface 205 can include a user interface suitable to allow a user to access the system. For example, or on-board applications, the user interface 205 may include a touchscreen display and one or more associated buttons on a vehicle head unit or navigation system. The displayed content can include personalized information or entertainment content such as videos, games, maps, navigation, vehicle diagnostics, calendar information, weather information, vehicle climate controls, vehicle entertainment controls, email, internet browsing, or any other interactive applications associated with the recognized occupant, whether the information originates onboard and/or off board the vehicle 2. Furthermore, the vehicle passengers may interact with the system via an on-board user interface or through a personal electronic device such as a smart phone or tablet which communicates therewith, through Bluetooth, RFID or other wireless technology standards to exchange data.

Customized vehicle dynamic display system 200 may also include data storage 209 such as, for example, a hard disk drive, solid-state drive, flash memory, or other storage unit that can store information such as access parameters or other data used by the system when modifying configuration settings.

Sensors 252 can include, for example, sensors 52 such as those described above with reference to the example of FIG. 1. Sensors 252 can include additional sensors that may or not otherwise be included on a standard vehicle 2 with which the customized vehicle dynamic display system 200 is implemented. In the illustrated example, sensors 252 include occupant presence sensors 252A (e.g., temperature sensor to detect seat temperature), occupant location sensors 252B (e.g., pressure sensor to detect occupant seat), occupant load sensors 252C (e.g., load cell to detect weight), occupant shape sensors 252D (e.g., ultrasonic sensor to detect pets), occupant face/body sensors 252E (e.g., image sensor or camera to provide identification), occupant orientation sensors 252F (e.g., inertial measurement unit to detect reach), occupant motion sensors 252G (e.g., 3-axis accelerometer), user interface proximity sensors 252H (e.g., photoelectric sensor), and user interface contact sensors 252I (e.g., capacitive screen to capture application frequency and content). Additional sensors 252X can also be included as may be appropriate for a given implementation of customized vehicle dynamic display system 200. These sensors 252 may be used to gather data that can be used to evaluate occupant identification and corresponding habits. Furthermore, data from all the sensors 252 may alternatively or additionally be combined for use by the system 200. For example, the temperature or pressure sensor can be used in conjunction with the imaging sensor to detect and/or confirm occupant location in the vehicle.

Vehicle systems 240 can include any of a number of different vehicle components or subsystems used to control or monitor various aspects of the vehicle. In this example, the vehicle systems 240 include auxiliary user interfaces 272; stored identifier/profile 274 dictating ergonomic settings of applicable vehicle systems; climate control system 276 to modify temperature at various locations in the vehicle (e.g., seat warmer); and other vehicle systems.

During operation, occupant display customizing circuit 210 can receive information from one or more of vehicle sensors 252 to collect information that might be used to build occupant identifiers/profiles and to determine whether available occupant identifiers/profiles should be utilized to tailor a user interface accordingly. Communication circuit 201 can be used to transmit and receive information between occupant display customizing circuit 210 and sensors 252, and vehicle systems 240. Also, sensors 252 may communicate with vehicle systems 240 directly or indirectly (e.g., via communication circuit 201 or otherwise). For example, communication circuit 201 can be used to send signals to one or more of: auxiliary user interface(s) 272 to control the display of additional passenger user interfaces; access or provide occupant identifiers/profiles 274 to, for example, adjust ergonomic features of applicable vehicle systems such as seat height; climate control system 276 (e.g., to adjust temperature at determined seating position). For the sake of brevity, further vehicle systems with the ability to modify their settings to benefit occupant's specific preferences are encompassed by other 282 (e.g., vehicle operating conditions, road conditions, traffic conditions, weather, etc.). Other 282 could employ sensors 52 to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. The decision regarding what action to take via these various vehicle systems 240 can be made based on the occupant profile, seating position, and vehicle systems parameters inside and outside the vehicle. Examples of this are described in more detail below.

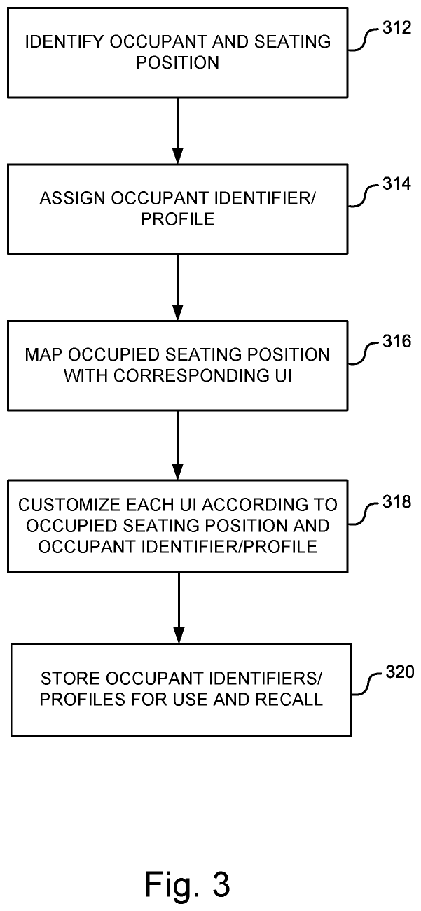

FIG. 3 illustrates an example process for implementing customized displays in accordance with embodiments of the systems and methods disclosed herein. With reference now to FIG. 3, at operation 312 a customized vehicle dynamic display system collects occupant characteristics for a plurality of occupants and for a plurality of seating positions. For example, sensor data (e.g., from sensors 52, 252) can be gathered to determine the number of occupants, the type of occupants, the preferences of occupants, and the position of occupants. This information can be used to not only adjust the display of the user interface but also to allow or disallow access to certain user interface functions associated with the particular driver and/or passenger. Additionally, an occupant with unlimited access as determined by occupant profile can nonetheless be blocked from accessing particular functions when occupying the driver's seat of a moving vehicle.

At operation 314, the collected occupant characteristics are analyzed to build and assign a unique occupant identifier/profile. In some embodiments, the system applies a generic profile for occupant's that fall within a certain demographic. For example, the system can quickly determine weight of the occupant is under 90 pounds and based on said weight assign a generic child identifier/profile. Alternatively, depending on the occupant, the identifier/profile can be created or retrieved from storage (e.g., memory 208 or cloud-based systems 343) of the customized vehicle dynamic display system 200. The identifier/profile may specify, for example, personal interest information. In some embodiments, this can be a relatively high-level specification such as specifying personal interest categories in two, three, four, five, six or more different categories. Further to this example, categories might be styled as such as personal calendar and event information, driving/destination history, web browsing history, entertainment preferences, and climate preferences.

At operation 316, the determined occupant identifier/profile including the seating position are correlated to the corresponding user interface. That is, each occupant will have a particular user interface associated with their interactions. The system automatically maps associations based on collected sensor data.

At operation 318, based on the mapped occupied seating position with corresponding user interface, the user interface of each occupant of the plurality of occupants is customized based on the occupant identifier/profile and location. For example, the system can automatically adjust the display to emphasize frequently used features by presenting most frequently-accessed/used applications with larger icons or a brighter setting. Ultimately, the display of each user interface can be adapted to be more in line with an occupant's physical and mental characteristics.

At operation 320, the identifier/profiles created are stored for recall and use. These profiles may be downloaded to the vehicle and stored on board for later recall when a previous occupant enters the vehicle. In another embodiment, the profiles may be stored remotely (e.g. in a cloud-based or other remote storage system) and a profile corresponding to an occupant may be downloaded to the vehicle when the occupant sits in the vehicle.

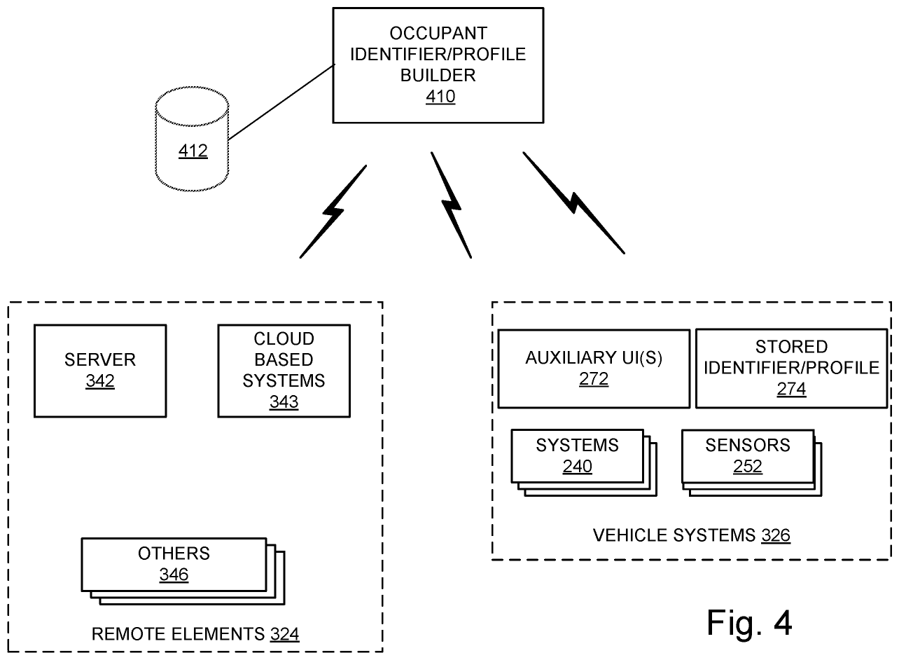

FIG. 4 illustrates an example profile system for building and storing identifiers/profiles in accordance with one embodiment. Referring now to FIG. 4, a profile builder 410 is provided along with an associated data store 412. Profile builder 410 collects information from a plurality of different sources to build a plurality of occupant profiles. Profile builder 410 may be, for example, a cloud-based server or other computing system, or a distributed computing system, to collect information and occupant profiles. In other implementations, profile builder 410 may be a vehicle-based computing system to gather information and build profiles (e.g., implemented as part of customizing display circuit 210) or a cloud-based distributed computing platform 343. As these examples illustrate, profile builder 410 may be implemented utilizing one or more computing resources at one or more various locations.

In the illustrated example, profile builder 410 collects information from remote elements 324 and vehicle systems 326. The information collected can be tagged such that the data can be associated with a particular user interface (e.g., front, back, or window location). Profile builder 410 gathers the information from these sources, correlates the gathered information to its associated respective classification, and analyzes the information to build identifiers/profiles. An example of this is illustrated at FIG. 3.

In the example illustrated of FIG. 4, vehicle systems 326 from which information may be gathered to build identifiers/profiles may include sensor data from sensors 252, 52 and system information such as from systems 240 that can be analyzed to determine vehicle operating characteristics and occupant behaviors or habits for the classification.

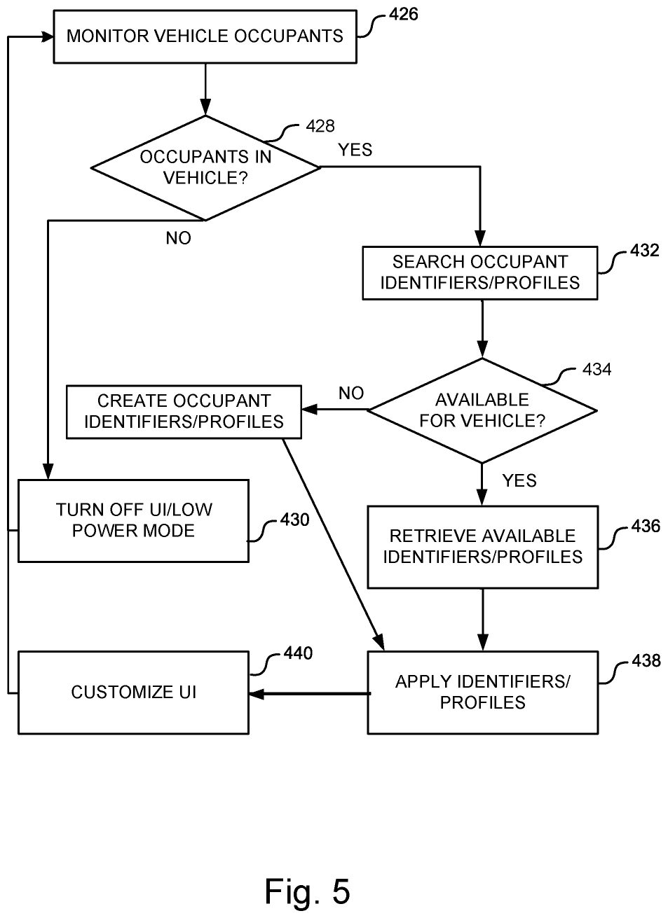

FIG. 5 illustrates an example process by which a customized vehicle display system utilizes identifiers/profiles for user interface display dynamics in accordance with one embodiment of the systems and methods disclosed herein. With reference now to FIG. 5, at operation 426 the system monitors the current vehicle occupants. For example, pressure sensor, temperature sensor or camera deployed inside the vehicle can monitor the current location of an occupant. This information may be maintained on board the vehicle such as for an onboard customized display system (e.g., customizing display circuit 210), or it may be transmitted to an auxiliary storage means external to the vehicle.

At operation 428 the system determines whether the occupant is within the vehicle and if so, which seating position the occupant is currently in. This may be determined, for example, using information from the pressure sensor, temperature sensor or camera. If the occupant is not in the vehicle (e.g., occupant places moving box in backseat which has an associated user interface), the system goes into a state requiring less power, such as sleep mode, but continues to monitor vehicle occupants. That is, the system does not modify the user interface (e.g., unchanged backseat user interface with box occupying seating position).

If the vehicle has occupants with an associated identifier/profile, the system searches the profiles at operation 432 to determine whether there is an identifier/profile available that is compatible with the sensed occupant characteristics. For example, the system may determine whether a profile matching the sensing occupant characteristics has already been created. If a profile does not exist for the occupant, or for the vehicle, (as illustrated at operation 434) the system creates a new identifier/profile capturing the attributes of the occupant including the seating position.

If, on the other hand, an occupant identifier/profile does exist for that vehicle, the identifier/profile is retrieved at operation 436 and applied to the user interface of the vehicle at operation 438 which customizes the user interface 440 accordingly. In various embodiments, the settings identified by the identifier/profile, as applicable to the user interface of the vehicle (e.g., home screen arrangement, preferred applications, font size, entertainment content, etc.), are applied to adjust one or more corresponding vehicle systems. In some embodiments, the identifier/profile may operate to adjust the climate control system or predict ergonomic settings of applicable vehicle systems from among a plurality of preprogrammed ergonomic settings. In other embodiments, the identifier/profile may operate to adjust various vehicle systems individually in accordance with the identifier/profile requirements.

For example, an onboard system such as the customizing display circuit 210 may be configured to retrieve the available identifier/profile operation 436 and apply the retrieved identifier/profile at operation 438. Customizing display circuit 210 may retrieve the available identifier/profile such as by retrieving it from a storage location (e.g., on board the vehicle) or by receiving it from an external system such as, for example, an external identifier/profile generation system.

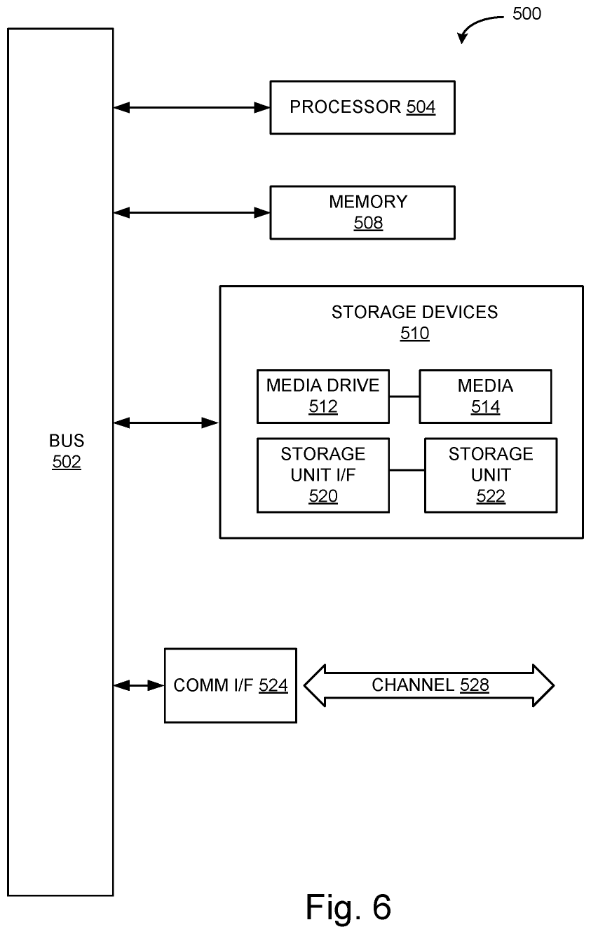

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 500. After reading this description, it will become apparent to a person skilled in the relevant art how to implement the application using other computing components or architectures.

Referring now to FIG. 6, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX, or another interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of customizing a vehicle display environment for a vehicle, comprising:
determining an occupant identifier for at least one occupant in the vehicle;
determining a seating position occupied by the at least one occupant in the vehicle and a UI corresponding to the at least one occupant;
determining an unoccupied seating position in the vehicle and a UI corresponding to the unoccupied seating position;
configuring each UI corresponding to the occupied seating position so as to customize each UI for the occupant at the corresponding seating position based on the determined occupant identifier,
wherein a classification of at least one occupant comprises a generic classification based on a weight of the at least one occupant,
wherein the corresponding UI is configured to provide tailored functions based on the generic classification, and
wherein the tailored functions not based on the generic classification are a subset of functions tailored to a child; and
configuring each UI corresponding to the unoccupied seating position so as to customize each UI corresponding to the unoccupied seating position for a low power state.

2. The method of claim 1, further comprising tracking occupant interactions with a UI for each occupant to learn occupant UI preferences based on the occupant interactions with the UI, and storing the occupant UI preferences with the corresponding occupant identifier.

3. The method of claim 1, wherein determining an occupant identifier for each of a plurality of occupants comprises determining an identity of the at least one occupant or determining a classification of the at least one occupant.

4. The method of claim 3, wherein a classification of at least one occupant comprises at least two of an age classification, height classification, weight classification, shape classification, and species classification.

5. The method of claim 1, wherein the occupant identifier further comprises a plurality of user preferences, and applying the occupant identifier to the vehicle comprises applying one or more of the plurality of user preferences to the vehicle.

6. (canceled)

7. The method of claim, wherein the tailored functions based on the generic classification are a subset of functions available to an occupant having a weight over 90 lbs.

8. The method of claim 1, further comprising gathering UI operating characteristics data from a plurality of sensors and constructing the occupant identifier based on the UI operating characteristics data for the at least one occupant.

9. The method of claim 1, wherein the occupant identifier is stored in an external storage location from the vehicle and retrieving the occupant identifier corresponding to the determined occupied position comprises receiving at the vehicle the occupant identifier transmitted from the external storage location.

10. (canceled)

11. A method of operating a system for a vehicle, comprising:
detecting an occupant in the vehicle;
identifying by an occupant identification subsystem whether the occupant is a previous user or a new user;
identifying by a position identification subsystem whether the occupant is a passenger or a driver;
assigning an occupant identifier based on the identifications from the occupant identification subsystem and the position identification subsystem;
generating an output for display on at least one vehicle interface corresponding to the occupant identifier, wherein the output comprises an arrangement of functions and a particular set of functions based on a state of the vehicle,
wherein a classification of the occupant comprises a generic classification based on a weight of the occupant,
wherein the at least one vehicle interface is configured to provide tailored functions based on the generic classification, and
wherein the tailored functions not based on the generic classification are a subset of functions tailored to a child; and
configuring the at least one vehicle interface for a sleep mode in response to an occupant not being detected in the vehicle.

12. A non-transitory machine-readable medium having instructions stored therein, which when executed by a processor, cause the processor to perform operations, the operations comprising:
determining an occupant identifier for at least one occupant in a vehicle;
determining a seating position occupied by the at least one occupant in the vehicle and a UI corresponding to each occupied seating position;
determining a seating position occupied by a non-human object in the vehicle and a UI corresponding to the non-human object seating position;
configuring each UI corresponding to the occupied seating position to customize each UI for the occupant at the corresponding seating position based on the determined occupant identifiers, wherein the customization of each UI further comprises displaying and providing access to functions based on a state of the vehicle,
wherein configuring each UI corresponding the occupied seating position to customize each UI for the occupant at the corresponding seating position comprises a machine learning model trained based on historical data including occupant interactions with each UI in the vehicle; and
configuring each UI corresponding to the non-human object seating position to customize each UI corresponding to the non-human object seating position to a state different from each UI corresponding to the occupied seating position.

13. The machine-readable medium of claim 12, further comprising tracking occupant interactions with a UI for each occupant to learn occupant UI preferences based on the occupant interactions with the UI, and storing the occupant preferences with the corresponding occupant identifier.

14. The machine-readable medium of claim 12, wherein determining an occupant identifier for at least one occupant comprises determining an identification of the least one occupant or determining a classification of the at least one occupant.

15. The machine-readable medium of claim 14, wherein a classification of at least one occupant comprises at least two of an age classification, height classification, weight classification, shape classification, and species classification.

16. The machine-readable medium of claim 12, wherein the occupant identifier further comprises a plurality of user preferences, and applying the occupant identifier to the vehicle comprises applying one or more of the plurality of user preferences to the vehicle.

17. The machine-readable medium of claim 12, further comprising gathering UI operating characteristics data from a plurality of sensors and constructing the occupant identifier based on the UI operating characteristics data for the at least one occupant.

18. The machine-readable medium of claim 12, wherein the occupant identifier is stored in an external storage location from the vehicle and retrieving the occupant identifier corresponding to the determined occupied position comprises receiving at the vehicle the occupant identifier transmitted from the external storage location.

19. (canceled)

20. A customizable vehicle dynamic display system, comprising:
a position determination system to determine a seating position and a UI corresponding to each occupied seating position for at least one occupant and each unoccupied seating position in a vehicle; and
an occupant display customizing circuit to determine an occupant identifier corresponding to the determined seating position, the occupant display customizing circuit configured to apply the determined occupant identifier to each occupied seating position so as to alter a display of the UI to conform to occupant characteristics,
wherein the occupant display customizing circuit is further configured to change a state of the UI corresponding to each unoccupied seating position, and
wherein the occupant display customizing circuit is further configured to customize each UI for the occupant at the corresponding seating position using a machine learning model trained based on historical data including occupant interactions with each UI in the vehicle.

21. The system of claim 20, wherein the changed state of the UI corresponding to each unoccupied seating position comprises a state requiring less power while the position determination system determines each occupied seating position and each unoccupied seating position in the vehicle.

22. The machine-readable medium of claim 12, further comprising configuring each UI corresponding to the non-human object seating position to customize each UI corresponding to the non-human object seating position for a sleep state.

23. The machine-readable medium of claim 12, wherein the machine learning model is associated with a vehicle profile and stored in the vehicle.

24. The machine-readable medium of claim 12, wherein the machine learning model is associated with a vehicle profile and stored in a cloud storage.
